(19) United States
(12) Patent Application Publication
(10) Pub. No.: US 2025/0241342 A1
(43) Pub. Date: Jul. 31, 2025

(54) METHOD FOR SHORTENING TIME REQUIRED FOR FRYING, AND METHOD FOR MINIMIZING OIL SPATTERING DURING FRYING

(71) Applicant: J-OIL MILLS, INC., Tokyo (JP)

(72) Inventors: Noriko TOKURA, Tokyo (JP); Miyuki MATSUSHIMA, Tokyo (JP); Tomoki KIRIYAMA, Tokyo (JP); Ken KUSAMA, Tokyo (JP); Shuichi KAMO, Tokyo (JP); Hiroki ISHIDA, Tokyo (JP); Kaori HIRAOKA, Tokyo (JP); Kumiko SUZUKI, Tokyo (JP)

(21) Appl. No.: 19/020,226

(22) Filed: Jan. 14, 2025

(30) Foreign Application Priority Data
Jan. 25, 2024 (JP) 2024-009800

(51) Int. Cl. A23L 5/10

(52) U.S. Cl. CPC A23L 5/11

(57) ABSTRACT

There is provided a method for accomplishing, in frying, one or both selected from shortening the time required for the frying and minimizing oil spattering during the frying. An oil and fat composition containing an edible oil and fat and a glycerin fatty acid ester.

### TECHNICAL FIELD

The present invention relates to a method for accomplishing, in frying, one or both selected from shortening the time required for frying and minimizing oil spattering during frying, wherein an oil and fat composition containing an edible oil and fat and a glycerin fatty acid ester is used in the frying.

### BACKGROUND ART

In recent years, demand for simplification in cooking has increased. In particular, there is desire to carry out frying using as little frying oil as possible, from the standpoints of treating the frying oil, cleaning a cooking location, and the like. However, in frying using a small amount of frying oil (also referred to below as “shallow frying”), the oil temperature decreases due to introduction of a frying ingredient and the frying ingredient is not entirely immersed in the frying oil. Therefore, problems arise in that the frying ingredient remains half-cooked if the frying time is not increased and in that the external appearance and mouthfeel of the frying ingredient are unsatisfactory.

As a means for resolving the aforementioned problems in shallow frying, Patent Document 1 discloses a mix for frying ingredients, the mix containing a wheat flour, 0.5-50 mass % of a cereal flour that is not a wheat flour, 0.3-10 mass % of an emulsifier, and 0.05-5 mass % of a leavening agent.

### PRIOR ART DOCUMENTS

### Patent Documents

[Patent Document 1] International Publication No. WO 2017/204324

### DISCLOSURE OF THE INVENTION

### Problems the Invention is Intended to Solve

However, Patent Document 1 neither discloses nor suggests an oil and fat composition for shallow frying. Furthermore, Patent Document 1 does not disclose reducing frying time or minimizing oil spattering.

### Means for Solving the Aforementioned Problems

The inventors discovered, as a result of thorough investigations, that using an oil and fat composition containing a specific emulsifier shortens the time required for frying and minimizes oil spattering during frying.

Specifically, according to the present invention, there is provided a method for accomplishing, in frying, one or both selected from shortening the time required for the frying and minimizing oil spattering during the frying, wherein an oil and fat composition containing an edible oil and fat and a glycerin fatty acid ester is used in the frying. The glycerin fatty acid ester content of the oil and fat composition is preferably 0.01 mass % or more and 8 mass % or less.

The glycerin fatty acid ester is preferably one or more selected from polyglycerin fatty acid esters, glycerin organic acid fatty acid esters, and polyglycerin condensed ricinoleic acid esters.

A frying ingredient supplied in the frying is preferably one or both selected from a breaded ingredient and a batter-coated ingredient.

### Effect of the Invention

According to the present invention, an effect for shortening the time required for frying or an effect for minimizing oil spattering during the frying occur in frying, and it is possible to provide a method having the aforementioned effects.

### BEST MODE FOR CARRYING OUT THE INVENTION

Embodiments of the present invention are described below.

Any combination of the configurations therein, or any item resulting from switching the expressions in the present invention between “method,” “device,” and the like, will be valid as an aspect of the present invention.

When upper-limit values and lower-limit values for numeric ranges are indicated in the present description, the upper-limit values and lower-limit values can be combined, as appropriate, and the numeric ranges obtained as a result are also disclosed in the present description.

The method for carrying out frying (cooking in which frying is employed) in the present invention is not particularly limited; examples include deep frying and shallow frying. Shallow frying is preferred. “Shallow frying” refers to a cooking method in which, in frying, the frying is carried out using a small amount of frying oil. For example, the height of the frying oil from the bottom surface of a frying pan, pot, or other cooking implement is 10 mm or less at the highest portion. Additionally, for example, the height of the oil before a frying ingredient is introduced into the oil is 20% or more and 80% or less of the thickness of the frying ingredient, preferably 22% or more and 78% or less, more preferably 25% or more and 75% or less, even more preferably 26% or more and 73% or less, and yet even more preferably 30% or more and 70% or less.

The oil and fat composition used in the present invention is characterized by containing an edible oil and fat and a glycerin fatty acid ester. The components within the oil and fat composition used in the present invention shall be described below.

### Edible Oil and Fat

There is no particular limitation as to a raw-material oil and fat used in the oil and fat composition, provided that the raw-material oil and fat is to be supplied to a food product. Examples of the raw-material oil and fat include: rapeseed oil, soybean oil, corn oil, rice bran oil, peanut oil, safflower oil, sunflower oil, cottonseed oil, sesame oil, grapeseed oil, linseed oil, perilla oil, walnut oil, pumpkinseed oil, camellia oil, tea seed oil, olive oil, wheat germ oil, palm olein, palm oil, palm kernel oil, coconut oil, sal fat, cacao butter, shea butter, and other plant-based oils and fats; beef tallow, pig lard, chicken fat, milk fat, fish oil, and other animal-based oils and fats; and medium-chain fatty acid triglycerides and other synthetic oils and fats.

It is also possible to use processed oils and fats obtained by performing one or more processes selected from hardening, fractionation, and trans-esterification on the aforementioned oils and fats. One or more of these raw-material oils and fats may be mixed together. The raw-material oil and fat preferably includes one or more selected from rapeseed oil, soybean oil, corn oil, sunflower oil, and palm olein, more preferably includes one or more selected from rapeseed oil, soybean oil, corn oil, and palm olein, and even more preferably includes one or both selected from rapeseed oil and soybean oil. The iodine value of the edible oil and fat in the present invention is not particularly limited. The iodine value is preferably 40 or higher and 200 or lower, more preferably 45 or higher and 170 or lower, even more preferably 50 or higher and 160 or lower, and yet even more preferably 55 or higher and 150 or lower.

### Glycerin Fatty Acid Ester

The glycerin fatty acid ester is one type of emulsifier. In the present embodiment, the glycerin fatty acid ester content of the oil and fat composition is preferably 0.01 mass % or higher and 8 mass % or lower, more preferably 0.05 mass % or higher and 5 mass % or lower, even more preferably 0.08 mass % or higher and 3 mass % or lower, yet even more preferably 0.08 mass % or higher and 2 mass % or lower, and particularly preferably 0.1 mass % or higher and 1 mass % or lower.

A constituent fatty acid of the glycerin fatty acid ester is not particularly limited. The constituent fatty acid is preferably a C12 or higher and C22 or lower fatty acid, more preferably a C14 or higher and C20 or lower fatty acid, even more preferably a C18 fatty acid, and yet even more preferably one or both selected from oleic acid and condensed ricinoleic acid.

The hydrophile-lipophile balance (HLB) value of the glycerin fatty acid ester is not particularly limited. For example, the HLB value is 2 or higher and 10 or lower, preferably 3 or higher and 10 or lower, more preferably 4 or higher and 9 or lower, and even more preferably 5 or higher and 8 or lower.

The HLB value can be calculated using the Atlas calculation method. “Atlas calculation method” refers to a method for calculating the HLB from the formula below. The saponification value in the formula can be measured in conformance with, e.g., “Standard methods for the analysis of fats, oils and related materials: 2.3.2,” and the neutralization value in the formula can be measured in conformance with, e.g., “Standard methods for the analysis of fats, oils and related materials: 3.3.1.”

HLB=20×(1−S/A)
S: Saponification value
A: Neutralization value of fatty acid in ester

Examples of the type of the glycerin fatty acid ester include monoglycerin fatty acid esters, polyglycerin fatty acid esters, glycerin organic acid fatty acid esters, and glycerin condensed ricinoleic acid esters. The glycerin fatty acid ester is preferably one or more selected from polyglycerin fatty acid esters, glycerin organic acid fatty acid esters, and polyglycerin condensed ricinoleic acid esters, and is more preferably one or more selected from polyglycerin fatty acid esters and polyglycerin condensed ricinoleic acid esters.

The average degree of polymerization of the polyglycerin in the polyglycerin fatty acid ester is not particularly limited. The average degree of polymerization is preferably 2 or higher and 25 or lower, more preferably 2 or higher and 22 or lower, even more preferably 2 or higher and 15 or lower, yet even more preferably 2 or higher and 13 or lower, and particularly preferably 2 or higher and 10 or lower.

Examples of the glycerin organic acid fatty acid ester include glycerin acetic acid fatty acid esters, glycerin lactic acid fatty acid esters, glycerin citric acid fatty acid esters, glycerin succinic acid fatty acid esters, and glycerin diacetyl tartaric acid fatty acid esters. The glycerin organic acid fatty acid ester is preferably a glycerin citric acid fatty acid ester. A glycerin citric acid monooleic acid ester is preferred as the glycerin citric acid fatty acid ester.

The oil and fat composition used in the present invention may contain components other than the edible oil and fat and the glycerin fatty acid ester within a range in which the purpose and effect of the present invention are not hindered. Examples include silicone, emulsifiers other than the glycerin fatty acid ester, flavorings, enzyme formulations, alkali formulations, phosphates, thickeners, colorants, antioxidants, bacteriostatic agents, seasonings, and other components that are ordinarily used in food products.

### Frying Ingredient

Methods for frying vegetables or the like without breading or batter, methods for breading a frying ingredient before frying, and methods for coating a frying ingredient with batter before frying are generally known in frying. In the present embodiment, examples of food products applied in frying include: vegetables fried without breading or batter; doughnuts, fried bread, corn dogs, and croutons, in which dough obtained by mixing flour, water, eggs, sugar, and the like is fried; fried rice crackers, in which dough having rice as a main component is fried; kara-age, tatsuta-age, and fried tofu, in which a frying ingredient is breaded and fried; and fritters, fried pork cutlets, fried chicken cutlets, chicken nanban, fried fish, tempura, croquettes, fried minced-meat cutlets, and chicken nuggets, in which a frying ingredient is coated with batter. Preferred examples include food products in which a frying ingredient is breaded and food products in which a frying ingredient is coated with batter. Examples of main ingredients used as frying ingredients include: shrimp, squid, scallops, sillago, goby, horse mackerel, conger eel, and other fish; carrots, onions, eggplants, green beans, sweet potatoes, pumpkins, potatoes, burdock, asparagus, and other vegetables; shiitake, maitake, enoki, and other mushrooms; beef, pork, chicken, duck, and other meats; and secondary ingredients of fish surimi or cream croquettes, dough for curry bread, and other products obtained by processing the aforementioned main ingredients.

The frying ingredient may be frozen, refrigerated, or normal temperature, but is preferably frozen or refrigerated, and more preferably frozen. In the present invention, “frozen” refers to being at a temperature less than 0° C., “refrigerated” refers to being at a temperature of 0° C. or higher but less than 12° C., and “normal temperature” refers to being at a temperature of 12° C. or higher but less than 40° C.

### Method for Producing Oil and Fat Composition

The method for producing the oil and fat composition used in the present invention is not particularly limited. The method may include a step for adding the glycerin fatty acid ester to the edible oil and fat. For example, it is possible to heat the edible oil and fat to approximately 60° C., add the glycerin fatty acid ester thereto in a prescribed amount, and then stir the resulting combination to achieve sufficient dissolution. It is also possible to heat part of the edible oil and fat and a prescribed amount of the glycerin fatty acid ester to approximately 60° C., stir the resulting combination to achieve sufficient dissolution, and then increase the amount of the edible oil and fat until a prescribed amount is reached.

### Method for Shortening Time Required for Frying

When frying is carried out using the oil and fat composition used in the present invention, the frying time can be shortened to less than that required when frying is carried out using an oil and fat composition to which no glycerin fatty acid ester is added. Additionally, when frying is carried out using the oil and fat composition used in the present invention, the frying ingredient is rapidly cooked.

The frying time is preferably 1 minute or more and 20 minutes or less, more preferably 4 minutes or more and 20 minutes or less, even more preferably 4 minutes or more and 15 minutes or less, and yet even more preferably 4 minutes or more and 10 minutes or less.

The frying temperature is preferably 150° C. or higher and 200° C. or lower, and more preferably 160° C. or higher and 200°° C. or lower.

### Method for Minimizing Oil Spattering During Frying

When frying is carried out using the oil and fat composition of the present invention, oil spattering during frying can be minimized to a greater extent than when frying is carried out using an oil and fat composition that does not contain the glycerin fatty acid ester used in the present invention. The rate of oil spattering during frying using the oil and fat composition of the present invention is, for example, 0% or higher and 80% or less, preferably 10% or more and 75% or less, more preferably 20% or more and 70% or less, even more preferably 25% or more and 68% or less, yet even more preferably 28% or more and 65% or less, and particularly 30% or more and 62% or less, where 100% represents the rate of oil spattering during frying using an oil and fat composition that does not contain the glycerin fatty acid ester used in the present invention. When frying is carried out using the oil and fat composition of the present invention, draining of moisture from the frying ingredient is promoted, and it is possible to smoothly drain moisture and to minimize bumping.

### EXAMPLES

Examples of the present invention are described below, but the present invention is not limited to these examples.

### Glycerin Fatty Acid Esters

Table 1 collectively shows the glycerin fatty acid esters used in tests described below.

| | | | | Average degree | | |
|---|---|---|---|---|---|---|
| | | Type of glycerin | | of polymerization | | Procurement |
| Name | HLB | fatty acid ester | Fatty acid | of polyglycerin | Trade name | source |
| O-500 | 7 | Polyglycerin | Oleic acid | 10 | Ryoto polyglyester | Mitsubishi |
| | | fatty acid ester | | | O-500 | Chemical Corp. |
| DO-100V | 7.4 | Polyglycerin | Oleic acid | 2 | Poem DO-100V | Riken Vitamin |
| | | fatty acid ester | | | | Co., Ltd. |
| 623M | 7 | Glycerin citric | Oleic acid | — | Sunsoft 623M | Taiyo Kagaku Co., |
| | | acid monooleic | | | | Ltd. |
| | | acid ester | | | | |
| CR-500 | 3 | Polyglycerin | Condensed | 6 | SY-glyster CR-500 | Sakamoto Yakuhin |
| | | condensed | ricinoleic | | | Kogyo Co., Ltd. |
| | | ricinoleic acid | acid | | | |
| | | ester | | | | |

The edible oils and fats used in the tests are indicated below.

### Edible Oils and Fats

Soybean oil: Refined soybean oil, iodine value 130, made by J-Oil Mills, Inc.

Rapeseed oil: Refined rapeseed oil, iodine value 110, made by J-Oil Mills, Inc.

Palm olein: iodine value 67, made by J-Oil Mills, Inc.

### Method for Preparing Oil and Fat Compositions

The glycerin fatty acid esters were added to the edible oils and fats so that prescribed blends were achieved to obtain oil and fat compositions of the examples. Specifically, the oil and fat compositions were prepared using the following method.
(1) A prescribed amount of the glycerin fatty acid ester was heated to 60° C.
(2) About 1/10 of a prescribed amount of the edible oil and fat was heated to 60°° C., the glycerin fatty acid ester from (1) was added thereto, and the resulting combination was stirred to achieve complete dissolution.
(3) The normal-temperature edible oil and fat was added to the mixture from (2) under stirring so that a prescribed blend was achieved.

### Test 1

An oil and fat composition of example 1-1 was prepared using the blend shown in table 2.

Oil and fat compositions of a control example, a comparative example, and example 1-1, which were used in the oil amounts listed in table 2, were introduced into flat-bottomed frying pans measuring 26 cm in diameter and heated to 180° C. Four frozen croquettes (New potato croquettes 60, made by Ajinomoto Frozen Food Co., Inc.) measuring 15 mm in thickness were introduced into each frying pan and fried for five minutes in the heated oil and fat. After frying was carried out, the oil was drained away and the internal temperature of the croquettes was measured.

The internal temperature was measured using the following procedure.

The probe portion of a handheld thermometer (trade name: Portable thermometer DP-350, made by RKC INSTRUMENT INC) was inserted into the fried croquettes to a depth of 70 mm in the long-axis direction of the croquettes, and the temperature was measured.

The results of evaluating the internal temperature are shown in table 2.

TABLE 2

| | | Control | Comparative | Example |
|---|---|---|---|---|
| | | example 1 | example 1 | 1-1 |
| Blend for oil and | Soybean | 100 | 100 | 99.85 |
| fat composition | oil | | | |
| (mass %) | O-50D | | | 0.15 |

| | | | |
|---|---|---|---|
| Amount of oil used during frying (g) | 400 | 300 | 300 |
| Height of oil surface from bottom | 13 | 10 | 10 |
| surface of frying pan (mm) | | | |
| Internal temperature (° C.) | 81.5 | 64.3 | 82.4 |

As shown in table 2, the internal temperature was low and the thoroughness of cooking was poor in comparative example 1, in which the amount of oil was reduced from that of the oil and fat in control example 1. However, the croquettes fried using the oil and fat composition of example 1-1 had a higher internal temperature than those in control example 1 and were thoroughly cooked, despite the use of the same amount of oil as in comparative example 1.

### Test 2

An oil and fat composition of example 2-1 was prepared using the blend shown in table 3.

Oil and fat compositions of a control example, a comparative example, and example 2-1, which were used in the oil amounts listed in table 3, were introduced into flat-bottomed frying pans measuring 28 cm in diameter and heated to 160° C. Five frozen croquettes (New potato croquettes 60, made by Ajinomoto Frozen Food Co., Inc.) measuring 15 mm in thickness were introduced into each frying pan and fried for five minutes in the heated oil and fat. After frying was carried out, the oil was drained away and the external appearance and mouthfeel of the croquettes were evaluated. The results of the evaluation are shown in table 3.

TABLE 3

| | | Control | Comparative | |
|---|---|---|---|---|
| | | example 2 | example 2 | Example 2-1 |
| Blend for | Soybean | 100 | 100 | 99.85 |
| oil and fat | oil | | | |
| composition | O-50D | | | 0.15 |
| (mass %) | | | | |

| Amount of oil used during frying (g) | 400 | 300 | 300 |
|---|---|---|---|
| Height of oil surface from bottom | 11 | 8 | 8 |
| surface of frying pan (mm) | | | |
| External appearance | Satisfactory | Partially poor | Satisfactory |
| | | coloration | |
| Mouthfeel | Crispy | Gooey coating; | Crispy |
| | mouthfeel; | unsatisfactory | mouthfeel; |
| | satisfactory | | satisfactory |

As shown in table 3, the mouthfeel and external appearance of the croquettes fried in comparative example 2, in which the amount of oil was reduced from that of the oil and fat in control example 2, were unsatisfactory. However, the croquettes fried using the oil and fat composition of example 2-1 had the same external appearance and mouthfeel as those in control example 2, despite the use of the same amount of oil as in comparative example 2. From the results of tests 1 and 2, it was found that when frying is carried out using the oil and fat composition of the present invention, despite the amount of oil being reduced, the thoroughness of cooking is excellent and an effect for shortening the frying time is achieved. Furthermore, it was also indicated that fried articles having a satisfactory external appearance and mouthfeel are obtained.

### Test 3

Oil and fat compositions of examples 3-1 to 3-3 were prepared using the blends shown in table 4.

Chicken nanban and fried pork cutlets were prepared in accordance with sections “(Method for preparing chicken nanban)” and “(Method for preparing fried pork cutlets)” below.

### Method for Preparing Chicken Nanban

(1) Skinned chicken breast meat (about 300 g, measuring about 25-30 mm in thickness) was coated with wheat flour (trade name: Nisshin cooking flour, made by Nisshin Seifun Welna Inc.) and eggs in the stated order.
(2) Oil and fat compositions of a control example, a comparative example, and examples 3-1 to 3-3, which were used in the oil amounts listed in table 4, were introduced into frying pans measuring 28 cm in diameter and heated to 160° C.
(3) The coated meat was introduced into the frying pans and fried for a total of 15 minutes, specifically for 8 minutes on one side and 7 minutes on the other side.

### Method for Preparing Fried Pork Cutlets

Fried pork cutlets were prepared according to the following procedure.
(1) A block of pork tenderloin was cut into pieces measuring 5 cm×7 cm×2 cm (slices measuring about 40 g).
(2) The cut meat was coated with wheat flour (trade name: Nisshin cooking flour, made by Nisshin Seifun Welna Inc.), eggs, and panko (trade name: Fry star 7, made by FRYSTAR CO., LTD) in the stated order.
(3) Oil and fat compositions of a control example, a comparative example, and examples 3-1 to 3-3, which were used in the oil amounts listed in table 4, were introduced into frying pans measuring 28 cm in diameter and heated to 180° C.
(4) The coated meat was introduced into the frying pans and fried for a total of 6 minutes, specifically for 3 minutes per side.

Immediately after preparation, each of the chicken nanban and the fried pork cutlets were cut, and the status of the interior thereof was observed. The results are shown in table 4.

| | | Control | Comparative | | | |
|---|---|---|---|---|---|---|
| | | example 3 | example 3 | Example 3-1 | Example 3-2 | Example 3-3 |
| Blend for oil and fat | Soybean | 100 | 100 | 99.95 | 99.85 | 99.5 |
| composition (mass %) | oil | | | | | |
| | O-50D | | | 0.05 | 0.15 | 0.5 |

| | | | | | |
|---|---|---|---|---|---|
| Amount of oil used during frying | 400 | 300 | 300 | 300 | 300 |
| (g) | | | | | |
| Height of oil surface from | 11 | 8 | 8 | 8 | 8 |
| bottom surface of frying pan | | | | | |
| (mm) | | | | | |
| Status of interior of chicken | Thoroughly | Raw center | Thoroughly | Thoroughly | Thoroughly |
| nanban | cooked | portion | cooked | cooked | cooked |
| Status of interior of fried | Thoroughly | Red center | Thoroughly | Thoroughly | Thoroughly |
| pork cutlets | cooked | portion | cooked | cooked | cooked |

As shown in table 4, the interior of the chicken nanban and the fried pork cutlets was raw in comparative example 3, in which the amount of oil was reduced from that of the oil and fat in control example 3. However, the chicken nanban and fried pork cutlets fried using the oil and fat compositions of examples 3-1 to 3-3 were thoroughly cooked in the same manner as those in control example 3, despite the use of the same amount of oil as in comparative example 3. Specifically, when frying is carried out using the oil and fat composition of the present invention, the frying time can be shortened. Additionally, it was found that carrying out frying using an oil and fat composition containing 0.05 mass % or more of 0-50D yields an effect for shortening the frying time.

### Test 4

Oil and fat compositions of examples 4-1 and 4-2 were prepared using the blends shown in table 5.

Chicken nanban was prepared using the same procedure as in section “(Method for preparing chicken nanban)” above, except that the oil and fat compositions of the control example, the comparative example, and the examples were replaced with oil and fat compositions of control example 4, comparative example 4, and examples 4-1 and 4-2. Immediately after frying, the chicken nanban was cut and the status of the interior thereof was observed. The results are shown in table 5.

TABLE 5

| | | Control | Comparative | Example | Example |
|---|---|---|---|---|---|
| | | example 4 | example 4 | 4-1 | 4-2 |
| Blend for | Rapeseed | 100 | 100 | 99.5 | 99.5 |
| oil and fat | oil | | | | |
| composition | 623M | | | 0.5 | |
| (mass %) | DO-100V | | | | 0.5 |

| | | | | |
|---|---|---|---|---|
| Amount of oil used during frying (g) | 400 | 300 | 300 | 300 |
| Height of oil surface from bottom | 11 | 8 | 8 | 8 |
| surface of frying pan (mm) | | | | |
| Status of interior of | Thoroughly | Raw center | Thoroughly | Thoroughly |
| chicken nanban | cooked | portion | cooked | cooked |

As shown in table 5, it was found that the effect for reducing frying time was exhibited even in cases where frying was carried out using an oil and fat composition prepared by using rapeseed oil as the edible oil and fat and adding 623 M or DO-100 V as the glycerin fatty acid ester.

### Test 5

An oil and fat composition of example 5-1 was prepared using the blend shown in table 6.

Chicken nanban was prepared using the same procedure as in section “(Method for preparing chicken nanban)” above, except that the oil and fat compositions of the control example, the comparative example, and the examples were replaced with oil and fat compositions of control example 5, comparative example 5, and example 5-1. Immediately after frying, the chicken nanban was cut and the status of the interior thereof was observed. The results are shown in table 6.

TABLE 6

| | | Control | Comparative | |
|---|---|---|---|---|
| | | example 5 | example 5 | Example 5-1 |
| Blend for oil and | Palm | 100 | 100 | 99.85 |
| fat composition | olein | | | |
| (mass %) | O-50D | | | 0.15 |

| Amount of oil used during frying (g) | 400 | 300 | 300 |
|---|---|---|---|
| Height of oil surface from bottom | 11 | 8 | 8 |
| surface of frying pan (mm) | | | |
| Status of interior of chicken nanban | Thoroughly | Raw center | Thoroughly |
| | cooked | portion | cooked |

As shown in table 6, it was found that the effect for reducing frying time was exhibited even in cases where frying was carried out using an oil and fat composition prepared by using palm olein as the edible oil and fat and adding 0-50D as the glycerin fatty acid ester.

### Test 6

An oil and fat composition of example 6-1 was prepared using the blend shown in table 7.

Oil and fat compositions of a control example, a comparative example, and example 6-1, which were used in the oil amounts listed in table 7, were introduced into flat-bottomed frying pans measuring 24 cm in diameter and heated to 160° C. Five frozen croquettes (New potato croquettes 60, made by Ajinomoto Frozen Food Co., Inc.) measuring 15 mm in thickness were introduced into each frying pan and fried for five minutes in the heated oil and fat. After frying was carried out, the oil was drained away, the internal temperature of the croquettes was measured, and the external appearance and mouthfeel of the croquettes were evaluated. The internal temperature was measured using the method described in test 1. The results of the evaluation are shown in table 7.

TABLE 7

| | | Control | Comparative | |
|---|---|---|---|---|
| | | example 6 | example 6 | Example 6-1 |
| Blend for | Rapeseed | 100 | 100 | 99.85 |
| oil and fat | oil | | | |
| composition | O-50D | | | 0.15 |

| (mass %) | | | |
|---|---|---|---|
| Amount of oil used during frying (g) | 500 | 250 | 250 |
| Height of oil surface from bottom | 17 | 9 | 6 |
| surface of frying pan (mm) | | | |
| Internal temperature | 82.1 | 74.8 | 84.9 |
| (° C.) | | | |
| External appearance | Satisfactory | Partially | Satisfactory |
| | | poor | |
| | | coloration | |
| | | Brittle and | |
| | | crumbling | |
| Mouthfeel | Crispy | Less crispy | Crispier |
| | mouthfeel; | mouthfeel | mouthfeel |
| | satisfactory | than control | than control |
| | | example 6 | example 6; |
| | | | satisfactory |

As shown in table 7, the internal temperature was low and the thoroughness of cooking was poor in comparative example 6, in which only rapeseed oil was used and the amount of oil was reduced. However, the croquettes fried using the oil and fat composition of example 6-1 had a higher internal temperature 10 than those in control example 6 and were thoroughly cooked, despite the use of the same amount of oil as in comparative example 6.

Additionally, the mouthfeel and external appearance of the croquettes fried in comparative example 6, in which the amount of oil was reduced from that in control example 6, were unsatisfactory. However, the croquettes fried using the oil and fat composition in example 6-1 had the same external appearance as those in control example 6 and were superior thereto in terms of mouthfeel, despite the use of the same amount of oil as in comparative example 6. From these results, it was indicated that when frying is carried out using the oil and fat composition of the present invention, thoroughness of cooking is excellent despite the amount of oil being reduced, and fried articles having a satisfactory external appearance and mouthfeel were obtained.

### Test 7

Oil and fat compositions of examples 7-1 to 7-7 were prepared using the blends shown in table 8.

Chicken nanban was prepared using the same procedure as in section “(Method for preparing chicken nanban)” above, except that the oil and fat compositions of the control example, the comparative example, and the examples were replaced with oil and fat compositions of control example 7, comparative example 7, and examples 7-1 to 7-7, and flat-bottomed frying pans measuring 26 cm in diameter were used. Immediately after frying, the internal temperature of the chicken nanban was measured, and furthermore, the chicken nanban was cut and the status of the interior thereof was observed. The results are shown in table 8.

The internal temperature of the chicken nanban was measured using the following procedure.

The probe portion of a handheld thermometer (trade name: Portable thermometer DP-350, made by RKC INSTRUMENT INC) was briefly inserted in a vertical orientation into the fried chicken nanban at the thickest portion thereof to the bottom, and the temperature was measured at a portion 10 mm above the bottom. The results of evaluating the internal temperature are shown in table 8.

| | | | Compar- | | | | | | | |
|---|---|---|---|---|---|---|---|---|---|---|
| | | Control | ative | Example | Example | Example | Example | Example | Example | Example |
| | | example 7 | example 7 | 7-1 | 7-2 | 7-3 | 7-4 | 7-5 | 7-6 | 7-7 |
| Blend | Rapeseed | 100 | 100 | 99.9 | 99.85 | 99.8 | 99.7 | 99.6 | 99.5 | 99.4 |
| for oil | oil | | | | | | | | | |
| and fat | O-50D | | | 0.1 | 0.15 | 0.2 | | | | |
| composition | CR-500 | | | | | | 0.3 | 0.4 | 0.5 | 0.6 |
| (mass %) | | | | | | | | | | |

| | | | | | | | | | |
|---|---|---|---|---|---|---|---|---|---|
| Amount of oil | 600 | 300 | 300 | 300 | 300 | 300 | 300 | 300 | 300 |
| used during | | | | | | | | | |
| frying (g) | | | | | | | | | |
| Height of oil | 19 | 9 | 9 | 9 | 9 | 9 | 9 | 9 | 9 |
| surface from | | | | | | | | | |
| bottom surface | | | | | | | | | |
| of frying pan | | | | | | | | | |
| (mm) | | | | | | | | | |
| Internal | 78.2 | 75.1 | 80.8 | 79.8 | 79.9 | 81.3 | 80.9 | 78.8 | 81.2 |
| temperature (° C.) | | | | | | | | | |
| Status of | Thoroughly | Raw | Thor- | Thor- | Thor- | Thor- | Thor- | Thor- | Thor- |
| interior of | cooked | center | oughly | oughly | oughly | oughly | oughly | oughly | oughly |
| chicken nanban | | portion | cooked | cooked | cooked | cooked | cooked | cooked | cooked |

As shown in table 8, the interior of the chicken nanban was raw in comparative example 7, in which the amount of oil was reduced from that of the oil and fat in control example 7. However, the chicken nanban fried using the oil and fat compositions of examples 7-1 to 7-7 were thoroughly cooked in the same manner as those in control example 7, despite the use of the same amount of oil as in comparative example 7. From this result, it was clarified that shallow frying was possible even in cases where frying was carried out using an oil and fat composition prepared by adding 0-50D or CR-500 as the glycerin fatty acid ester to rapeseed oil.

### Test 8

Oil and fat compositions of examples 8-1 and 8-2 were prepared using the blends shown in table 9.

The oil and fat compositions of examples 8-1 and 8-2, which were used in the oil amounts listed in table 9, were introduced into flat-bottomed frying pans measuring 28 cm in diameter and heated to 160° C. Five frozen croquettes (New potato croquettes 60, made by Ajinomoto Frozen Food Co., Inc.) measuring 15 mm in thickness were introduced into each frying pan and fried for five minutes in the heated oil and fat. After frying was carried out, the oil was drained away and the external appearance and mouthfeel of the croquettes were evaluated. The results of the evaluation are shown in table 9.

TABLE 9

| | | Example 8-1 | Example 8-2 |
|---|---|---|---|
| Blend for oil and fat | Soybean | 79.35 | 79.5 |
| composition (mass %) | oil | | |
| | Rapeseed | 20 | 20 |
| | oil | | |
| | O-50D | 0.15 | |
| | CR-500 | 0.5 | 0.5 |

| Amount of oil used in frying (g) | 300 | 300 |
|---|---|---|
| Height of oil surface from | 8 | 8 |
| bottom surface of frying pan (mm) | | |
| External appearance | Satisfactory | Satisfactory |
| Mouthfeel | Very crunchy | Crispy |
| | mouthfeel; | mouthfeel; |
| | satisfactory | satisfactory |

### Test 9

Oil and fat compositions of examples 9-1 and 9-2 were prepared using the blends shown in table 10.

Chicken nanban was prepared using the same procedure as in section “(Method for preparing chicken nanban)” above, except that the oil and fat compositions of the examples were replaced with oil and fat compositions of examples 9-1 and 9-2. Immediately after frying, the internal temperature of the chicken nanban was measured, and furthermore, the chicken nanban was cut and the status of the interior thereof was observed. The internal temperature was measured using the method described in test 7. The results are shown in table 10.

TABLE 10

| | | Example 9-1 | Example 9-2 |
|---|---|---|---|
| Blend for oil and fat | Soybean | 79.35 | 79.5 |
| composition (mass %) | oil | | |
| | Rapeseed | 20 | 20 |
| | oil | | |
| | O-50D | 0.15 | |
| | CR-500 | 0.5 | 0.5 |

| Amount of oil used in frying (g) | 300 | 300 |
|---|---|---|
| Height of oil surface from bottom | 8 | 8 |
| surface of frying pan (mm) | | |
| Internal temperature (° C.) | 73.2 | 77.7 |
| Status of interior of chicken nanban | Thoroughly | Thoroughly |
| | cooked | cooked |

As shown in tables 9 and 10, thoroughly cooked croquettes or chicken nanban having a satisfactory external appearance and mouthfeel were obtained in cases where frying was carried out using an oil and fat composition prepared by adding 0-50D or CR-500 as the glycerin fatty acid ester to a raw-material oil and fat in which soybean oil and rapeseed oil were mixed together. From this result, it was clarified that shallow frying is possible even in cases where frying was carried out using an oil and fat composition prepared by using an oil and fat mixture of soybean oil and rapeseed oil as the raw-material oil and fat.

### Test 10

Shrimp tempura was prepared in accordance with section “(Method for preparing shrimp tempura)” below using rapeseed oil and the oil and fat compositions of examples 7-1 to 7-3, and the rate of oil spattering during frying was evaluated as a grease spot area ratio. The resulting evaluation results are shown in table 11.

### Method for Preparing Shrimp Tempura

(1) Ice water in an amount that was 1.5 times the amount of tempura flour (Ogon, made by Showa Sangyo Co., Ltd.) was added to the tempura flower, and the resulting combination was stirred for one minute to prepare a batter liquid.
(2) Frozen shrimp (Frozen shelled shrimp, made by Value Plus) were thawed at normal temperature.
(3) The thawed shrimp were cleansed using water to obtain shelled shrimp. The shelled shrimp were collected in groups of six so as to reach 25-30 g.
(4) Oils and fats in a comparative example and examples 7-1 to 7-3, which were used in the oil amounts listed in table 11, were introduced into a single-handled pot measuring 15.5 cm in diameter and heated to 170° C.
(5) Six shelled shrimp were passed through the batter liquid and then introduced into the pot in (4).
(6) An A4 sheet of paper was placed on top of the single-handled pot to serve as a lid for the single-handled pot. The distance from the oil surface to the A4 sheet of paper at this time was 73 mm.
(7) After one minute had elapsed from (6), the A4 sheet of paper was removed, and shrimp tempura was taken out.
(8) The A4 sheet of paper was lightly wiped using a paper towel so as to be pressed thereby.
(9) The A4 sheet of paper was placed on a lightbox and an image was captured.
(10) The resulting image data was imported into ImageJ, and the grease spot area ratio with respect to the opening of the single-handled pot was measured.

TABLE 11

| | | Comparative | Example | Example | Example |
|---|---|---|---|---|---|
| | | example 10 | 7-1 | 7-2 | 7-3 |
| Blend for | Rapeseed | 100 | 99.9 | 99.85 | 99.8 |
| oil and fat | oil | | | | |
| composition | O-50D | | 0.1 | 0.15 | 0.2 |
| (mass %) | | | | | |

| | | | | |
|---|---|---|---|---|
| Amount of oil used during frying (g) | 300 | 300 | 300 | 300 |
| Height of oil surface from bottom | 25 | 25 | 25 | 25 |
| surface of single-handled pot (mm) | | | | |
| Grease spot area | 81.2 | 42.9 | 26.1 | 27.2 |
| ratio (%), first | | | | |
| instance | | | | |
| Second instance | 87.2 | 49.2 | 28.3 | 21.8 |
| Third instance | 76.1 | 55.4 | 37.4 | 26.9 |
| Average value | 81.5 | 49.2 | 30.6 | 25.3 |

As shown in table 11, carrying out frying using an oil and fat composition in which 0.1 mass % or more and 0.2 mass %5 or less of 0-50D was added as a glycerin fatty acid ester to rapeseed oil yielded a decrease in the grease spot area ratio relative to comparative example 10, in which only rapeseed oil was used. From this result, it was clarified that carrying out frying using the oil and fat composition of the present invention makes it possible to minimize oil spattering during 10 frying.

1. A method for accomplishing, in frying, one or both selected from shortening the time required for the frying and minimizing oil spattering during the frying, wherein an oil and fat composition containing an edible oil and fat and a glycerin fatty acid ester is used in the frying.

2. The method according to claim 1, wherein the glycerin fatty acid ester content of the oil and fat composition is 0.01 mass % or more and 8 mass % or less.

3. The method according to claim 1, wherein the glycerin fatty acid ester is one or more selected from polyglycerin fatty acid esters, glycerin organic acid fatty acid esters, and polyglycerin condensed ricinoleic acid esters.

4. The method according to claim 1, wherein a frying ingredient supplied in the frying is one or both selected from a breaded ingredient and a batter-coated ingredient.

5. The method according to claim 2, wherein the glycerin fatty acid ester is one or more selected from polyglycerin fatty acid esters, glycerin organic acid fatty acid esters, and polyglycerin condensed ricinoleic acid esters.

6. The method according to claim 2, wherein a frying ingredient supplied in the frying is one or both selected from a breaded ingredient and a batter-coated ingredient.
